(19) United States
(12) Patent Application Publication
(10) Pub. No.: US 2021/0019643 A1
(43) Pub. Date: Jan. 21, 2021

(54) PREDICTING THE IMPACT OF FLEXIBLE ENERGY DEMAND ON THERMAL COMFORT

(71) Applicant: Carrier Corporation, Palm Beach Gardens, FL (US)

(72) Inventors: Fabrizio Smith, Rome (IT); Matteo Rucco, Trento (IT); Alberto Ferrari, Rome (IT); Jason Higley, Pittsford, NY (US)

(21) Appl. No.: 16/982,276

(22) PCT Filed: Mar. 18, 2019
(86) PCT No.: PCT/US19/22746

§ 371 Date: Sep. 18, 2020

Related U.S. Application Data
(60) Provisional application No. 62/644,836, filed on Mar. 19, 2018.

(51) Int. Cl. G06N 5/04; G06N 20/00; G06F 16/23

(52) U.S. Cl. CPC G06N 5/04; G06F 16/2379; G06N 20/00

(57) ABSTRACT

A method and system for optimizing power usage of a building is disclosed. A method includes generating a profile for each user of a set of users of the building, using machine-learning techniques; retrieving data regarding the building; storing the profile and data in a knowledge base; and calculating power requirements of the set of users based on the profile and data.

### BACKGROUND

Exemplary embodiments pertain to the art of electronics. In particular, the present disclosure relates to a method and system for integrating smart buildings and a power grid.

While finding new, cleaner types of sources for energy production, another important aspect of the energy sector is to use less power. One manner of reducing power consumption is the use of “smart” buildings. A smart building provides building services at the lower cost, with the lowest environmental impact. A smart building utilizes sensors and information technology to more efficiently provide the services.

A simple example of “smart” technology is the light switch. A traditional light switch is manually operated by a person. A “smart” light switch can include a variety of technology such that lights are only used when needed. This can include motion sensors and/or timers such that lights are not unnecessarily used when the area being lit is not being used. More sophisticated methods can be used for other systems, such as elevators, and heating, ventilation, and air conditioning (HVAC) units.

Another technology used is a smart power grid. In such a situation, an electric utility can be in communication with a smart building. The communication can include information such as projected power usage (from the smart building) or limitations to power output (from the electric utility). It would be useful to enhance the communications between the smart building and the electric utility.

### BRIEF DESCRIPTION

According to one embodiment, a method and system for optimizing power usage of a building is disclosed. A method includes generating a profile for each user of a set of users of the building, using machine-learning techniques; retrieving data regarding the building; storing the profile and data in a knowledge base; and calculating power requirements of the set of users based on the profile and data.

In addition to one or more features described above, or as an alternative, further embodiments may include wherein the profile comprises a thermal profile of the user's thermal comfort level.

In addition to features described above, or as an alternative, further embodiments may include wherein the profile comprises building usage data regarding each user's use of other electric power of the building.

In addition to features described above, or as an alternative, further embodiments may include wherein calculating power requirements includes determining additional energy usage of the building not related to the set of users

In addition to features described above, or as an alternative, further embodiments may include wherein the data regarding the building comprises data regarding building dimensions and orientation.

In addition to features described above, or as an alternative, further embodiments may include receiving a request for power usage information; transmitting the power requirements; receiving a request to reduce power usage; and using machine-learning techniques to reduce power usage using the profile.

In addition to features described above, or as an alternative, further embodiments may include wherein reducing power usage using the profile comprises changing a thermal comfort level of the building while maintaining a predicted percentage of dissatisfied below a predetermined level

In addition to features described above, or as an alternative, further embodiments may include wherein reducing power usage further comprises determining non-essential services of the building to be turned off.

In addition to features described above, or as an alternative, further embodiments may include reducing power usage further comprises reducing lighting to a minimum acceptable lighting level.

In addition to features described above, or as an alternative, further embodiments may include transmitting a proposal of reduced power usage.

### BRIEF DESCRIPTION OF THE DRAWINGS

The following descriptions should not be considered limiting in any way. With reference to the accompanying drawings, like elements are numbered alike:

FIG. 1 is a flowchart illustrating the operation of one or more embodiments;

FIG. 2 is a flowchart illustrating the operation of one or more embodiments;

FIG. 3 is a block diagram of a computer system capable of performing one or more embodiments; and

FIG. 4 is a block diagram of an exemplary computer program product.

### DETAILED DESCRIPTION

A detailed description of one or more embodiments of the disclosed apparatus and method are presented herein by way of exemplification and not limitation with reference to the Figures.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

As described above, smart buildings are becoming more popular. A smart building utilizes information technology in conjunction with sensors to improve the user's experience while also improving the efficiency of the building. There can be a wide variety of functions that a smart building can perform to achieve those tasks. For example, as described above, manual light switches can be replaced with timers or sensors, to reduce after-hours or otherwise wasted electricity usage. Elevators can be made more efficient using schemes such as destination dispatch and other techniques to reduce elevator usage. Manually operated thermostats can be replaced with scheduled thermostats or with increasingly sophisticated systems that control the thermal environment of a building.

In one or more embodiments, machine-learning methods and systems can be used to predict and negotiate power usage between a smart building and an electric utility. Advancements in technology allow an electric utility to communicate with a smart building. This communication can allow the more efficient delivery of power, because the electric utility will be able to more accurately forecast power usage for a certain time period. The smart building will be able to provide accurate power usage forecasts through the use of thermal profiles and other information about building usage.

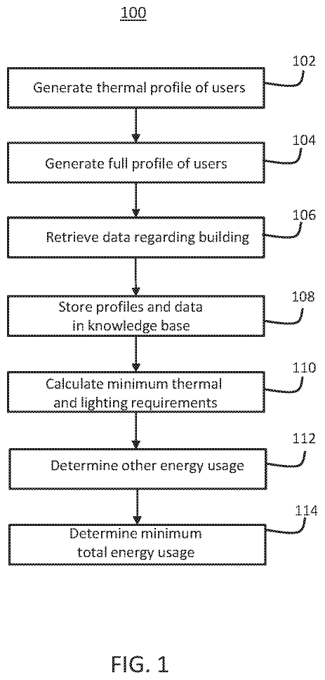

With respect to FIG. 1, a method 100 is presented that illustrates the operation of one or more embodiments. Method 100 is merely exemplary and is not limited to the embodiments presented herein. Method 100 can be employed in many different embodiments or examples not specifically depicted or described herein. In some embodiments, the procedures, processes, and/or activities of method 100 can be performed in the order presented. In other embodiments, one or more of the procedures, processes, and/or activities of method 100 can be combined, skipped, or performed in a different order. In some embodiments, method 100 can be executed by a system 300.

For each user of a building, a thermal profile is generated (block 102). As discussed in greater detail in co-pending patent application Ser. No. 62/644,813, titled Machine-Learning Method for Conditioning Individual or Shared Areas, incorporated herein by reference in its entirety, a thermal profile is used to determine if a user would be comfortable at a range of interior climate conditions. This can be measured using a Thermal Comfort algorithm. The thermal profile includes temperature of the room. And may also can include other aspects of the room, such as relative humidity, air velocity, and radiation (mean radiant temperature), as well as characteristics of the user, such as metabolic rate of the user, and the clothing worn by the user.

Thereafter, the interior area can be conditioned based on a calculated thermal comfort. A user's preferences can then be gathered in one of a variety of different methods, such as via a software application (or “app) on a mobile electronic device. The user's preferences (such as deviations from the calculated thermal comfort due to the user's sensitivity to heat or cold), is stored in a thermal profile. It should be understood that a user denotes any person in a building, whether the person is an owner, employee, tenant, contractor, or the like. It should further be understood that a thermal profile will be more accurate for a person who is regularly in a building, such as a tenant or employee. A person who is merely a guest may not have enough information to generate a thermal profile. In such a case, a thermal profile can be estimated.

A full profile is generated for each user (block 104). The thermal profile can be just one aspect of a user's full profile. The user's profile also can include additional information regarding the user's interactions with the building. These can include typical rooms being used by the user, typical elevator usage of the user, typical times of use of the building (e.g., for an office building, what time the user typically arrives at the office and leaves the office; for a residential building, what time the user's residence is typically in use). As stated above, a full profile generation might not be possible for a guest. In such a case, an estimated profile can be used.

The data for the thermal profile and the full profile can be retrieved in a variety of different manners. In a smart building, there are a wide variety of sensors throughout the building. The sensors can interact with and/or track a device carried by the user, such as a mobile electronic device (such as a smartphone, tablet, electronic reader, MP3 player, laptop computer, and the like), a key card, or biometrics (e.g., fingerprint sensors, facial recognition, retinal scan, and the like).

Data regarding the building is retrieved to further refine the full profile (block 106). The data can include dimensions of each room, typical usage information about each room, location of windows, orientation of the building (e.g., which side(s) of the building receives sun exposure), and the like.

The gathered data and profile information is stored in a knowledge base (block 108). A machine-learning system is used to calculate a variety of data. The data can include both ideal thermal and lighting requirements and minimal thermal and lighting requirements for the areas of the building being used (block 110). The profile data is aggregated to determine how much electricity would be needed to light and cool/heat the areas of the building. This is not a mere addition of the energy usage of each person, because some areas are shared. For example, an office with an “open” floor plan can have dozens of people sharing a single room. Using the profile data, one or more embodiments can determine that the single room includes multiple people and aggregate the data into a calculation of the power usage for the room.

As of today, there are established techniques for analyzing and simulating the energy performance and thermos-dynamic behavior of an HVAC system, given suitable models of the building structure/envelope and HVAC software and hardware. In the context of one or more embodiments, given a target thermal comfort value, it should be possible to infer the HVAC parameters that should be tuned to meet the target comfort value. These HVAC parameters can be used to configure building simulation tools and correlate thermal comfort levels with the profiles.

Other energy usage (such as common areas) is determined (block 112). This can include areas such as elevators, escalators, stairwells, rest rooms, and lobbies. Thereafter, in conjunction with modeling, simulation, and operational monitoring methods, an estimate is made of the minimum energy needed to keep the building operational, with a minimum impact on the comfort of the users (block 114).

This information can be used in a variety of different manners. In one or more embodiments, a smart power grid can involve a provider or distributor of electric power (such as an electric utility company). It can take a long period of time to add electricity to a power grid. Such a process can involve buying power from external power sources, putting additional generators on-line, and the like. Thus, it is in the best interest of an electric utility to determine how much power will be used. The electric utility does not want to run a generator unnecessarily, incurring costs and wasting power. Nor does the electric utility want to run out of power, possibly forcing actions as drastic as brownouts (a reduction in supplied voltage) or even planned blackouts (complete cessation of power delivery).

The electric utility can be in communication with smart buildings to determine an electric usage forecast. Such a forecast, if carried out with enough customers, can provide a more accurate estimate of power demand. While an electric utility can estimate power usage based on weather data and historical power usage, such estimates are not as reliable as they could be. Using method 100, a smart building would be able to provide a more accurate estimate of how much power will be used at a certain time period.

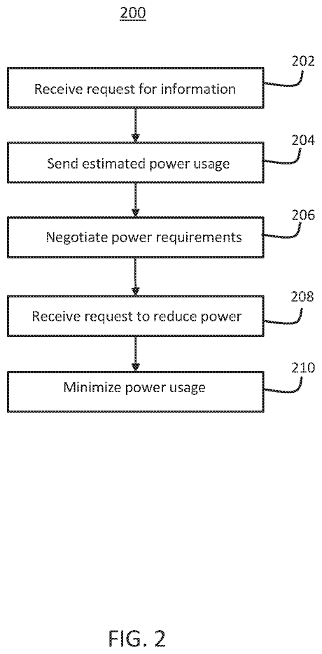

With respect to FIG. 2, a method 200 is presented that illustrates the operation of one or more embodiments. Method 200 is merely exemplary and is not limited to the embodiments presented herein. Method 200 can be employed in many different embodiments or examples not specifically depicted or described herein. In some embodiments, the procedures, processes, and/or activities of method 100 can be performed in the order presented. In other embodiments, one or more of the procedures, processes, and/or activities of method 200 can be combined, skipped, or performed in a different order. In some embodiments, method 200 can be executed by a system 300.

An electric utility sends an information request to a smart building (block 202). The information request can ask for an estimate of power usage during a certain time period. More particularly, an electric utility can send a proposal to the smart building. The proposal can include an update of energy prices, electric generation capabilities, and a time-frame for demand-side flexibility requests. Such information allows the smart building to optimize its operations.

Using, for example, method 200, a smart building can respond to information request by detailing its estimated power usage (block 204). Here, it can be assumed that the smart building optimizes the internal power consumption, in order to achieve the best trade-off between efficiency and thermal comfort. This can be accomplished using, for example, the techniques described in method 100, taking into account the proposal of block 202. The concept of predicted percentage of dissatisfied, described in further detail below, such that maximum flexibility in terms of energy demand can be computed. The demand-side flexibility is then transmitted to the electric utility.

Thereafter, a “negotiation” can take place (block 206). This can include a recommendation by the electric utility to the smart building. The demand-response process might not necessarily be triggered by limitations of the electric utility's ability to provide electricity. Demand-side flexibility might also be motivated by price variations, presence of local energy storage, fluctuating availability of renewable energy sources, district-level optimization of energy distribution, and the like.

In such a case, the electric utility can request that the building reduce its power usage by a certain amount (block 208). The smart building can try to re-optimize the operations in the building, according to the grid request. There also may be cases where the negotiation includes the “export” of energy from the building, for example, if the smart building has local storages of local renewables production units.

The smart building can then determine how to reduce the power while limiting impact on thermal comfort of users (block 210). In some instances, this can be as simple as turning off an elevator or turning off lighting for unoccupied floors. In other instances, a determination can be made as to how much a heating, ventilation, air conditioning (HVAC) usage can be reduced without negatively affecting the comfort of the users.

As detailed above, part of the process of developing a climate profile is determining a predicted percentage of dissatisfied (PPD), based on the thermal profile of the users and the interior conditions. Using machine-learning methods, one or more embodiments can determine thermal conditions that would reduce power usage by the requested amount, yet result in as low a PPD as possible, such as maintaining the PPD below a predetermined threshold level. Thermal conditions can include temperature, air velocity, and humidity. Thermal conditions also can include non-HVAC related mechanisms of the building. For example, shades can be pulled in windows that face the sunlight. Non-essential heat-generating equipment can be shut down or reduced in power consumption. In such a manner, the power consumption of the building can be reduced to an amount acceptable to the electric utility.

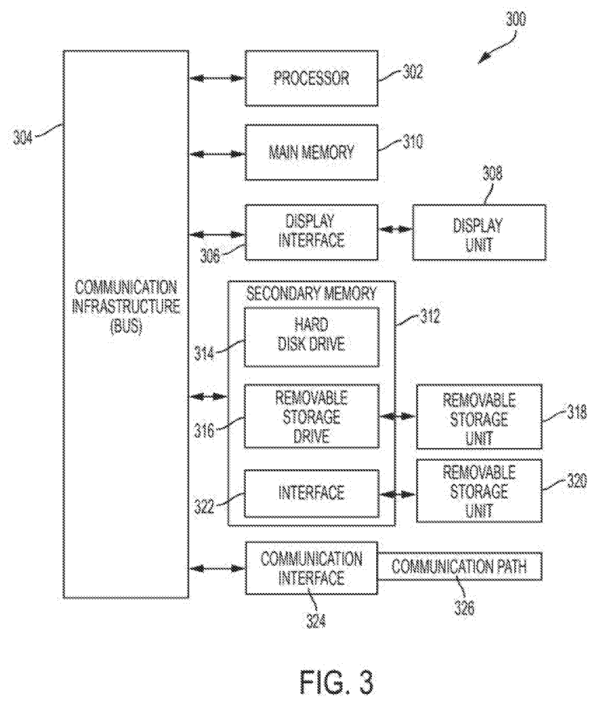

FIG. 3 depicts a high-level block diagram of a computer system 300, which can be used to implement one or more embodiments. More specifically, computer system 300 can be used to implement hardware components of systems capable of performing methods described herein. Although one exemplary computer system 300 is shown, computer system 300 includes a communication path 326, which connects computer system 300 to additional systems (not depicted) and can include one or more wide area networks (WANs) and/or local area networks (LANs) such as the Internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, textual content, and other data from communication infrastructure 304 (or from a frame buffer not shown) for display on a display unit 308. Computer system 300 also includes a main memory 310, preferably random access memory (RAM), and can also include a secondary memory 312. Secondary memory 312 can include, for example, a hard disk drive 314 and/or a removable storage drive 316, representing, for example, a floppy disk drive, a magnetic tape drive, or an optical disc drive. Hard disk drive 314 can be in the form of a solid state drive (SSD), a traditional magnetic disk drive, or a hybrid of the two. There also can be more than one hard disk drive 314 contained within secondary memory 312. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disc, etc. which is read by and written to by removable storage drive 316. As will be appreciated, removable storage unit 318 includes a computer-readable medium having stored therein computer software and/or data.

In alternative embodiments, secondary memory 312 can include other similar means for allowing computer programs or other instructions to be loaded into the computer system. Such means can include, for example, a removable storage unit 320 and an interface 322. Examples of such means can include a program package and package interface (such as that found in video game devices), a removable memory chip (such as an EPROM, secure digital card (SD card), compact flash card (CF card), universal serial bus (USB) memory, or PROM) and associated socket, and other removable storage units 320 and interfaces 322 which allow software and data to be transferred from the removable storage unit 320 to computer system 300.

Computer system 300 can also include a communications interface 324. Communications interface 324 allows software and data to be transferred between the computer system and external devices. Examples of communications interface 324 can include a modem, a network interface (such as an Ethernet card), a communications port, or a PC card slot and card, a universal serial bus port (USB), and the like. Software and data transferred via communications interface 324 are in the form of signals that can be, for example, electronic, electromagnetic, optical, or other signals capable of being received by communications interface 324. These signals are provided to communications interface 324 via communication path (i.e., channel) 326. Communication path 326 carries signals and can be implemented using wire or cable, fiber optics, a phone line, a cellular phone link, an RF link, and/or other communications channels.

In the present description, the terms “computer program medium,” “computer usable medium,” and “computer-readable medium” are used to refer to media such as main memory 310 and secondary memory 312, removable storage drive 316, and a hard disk installed in hard disk drive 314. Computer programs (also called computer control logic) are stored in main memory 310 and/or secondary memory 312. Computer programs also can be received via communications interface 324. Such computer programs, when run, enable the computer system to perform the features discussed herein. In particular, the computer programs, when run, enable processor 302 to perform the features of the computer system. Accordingly, such computer programs represent controllers of the computer system. Thus it can be seen from the forgoing detailed description that one or more embodiments provide technical benefits and advantages.

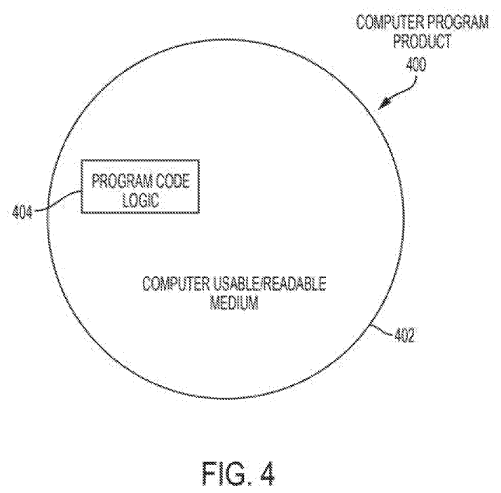

Referring now to FIG. 4, a computer program product 400 in accordance with an embodiment that includes a computer-readable storage medium 402 and program instructions 404 is generally shown.

Embodiments can be a system, a method, and/or a computer program product. The computer program product can include a computer-readable storage medium (or media) having computer-readable program instructions thereon for causing a processor to carry out aspects of embodiments of the present invention.

The computer-readable storage medium can be a tangible device that can retain and store instructions for use by an instruction execution device. The computer-readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out embodiments can include assembler instructions, instruction-set-architecture (ISA) instructions, machine instructions, machine dependent instructions, microcode, firmware instructions, state-setting data, or either source code or object code written in any combination of one or more programming languages, including an object-oriented programming language such as Smalltalk, C++ or the like, and conventional procedural programming languages, such as the “C” programming language or similar programming languages. The computer-readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer-readable program instructions by utilizing state information of the computer-readable program instructions to personalize the electronic circuitry, in order to perform embodiments of the present invention.

Embodiments may be implemented using one or more technologies. In some embodiments, an apparatus or system may include one or more processors and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., a processor, apparatus or system) to perform one or more methodological acts as described herein.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A computer-implemented method for optimizing power usage of a building comprising:
generating a profile for each user of a set of users of the building, using machine-learning techniques;
retrieving data regarding the building;
storing the profile and data in a knowledge base; and
calculating power requirements of the set of users based on the profile and data.

2. The computer-implemented method of claim 1, wherein:
the profile comprises a thermal profile of the user's thermal comfort level.

3. The computer-implemented method of claim 2, wherein:
the profile comprises building usage data regarding each user's use of other electric power of the building.

4. The computer-implemented method of claim 1, wherein:
calculating power requirements includes determining additional energy usage of the building not related to the set of users.

5. The computer-implemented method of claim 1, wherein:
the data regarding the building comprises data regarding building dimensions and orientation.

6. The computer-implemented method of claim 1, further comprising:
receiving a request for power usage information;
transmitting the power requirements;
receiving a request to reduce power usage;
using machine-learning techniques to reduce power usage using the profile.

7. The computer-implemented method of claim 6, wherein:
reducing power usage using the profile comprises changing a thermal comfort level of the building while maintaining a predicted percentage of dissatisfied below a predetermined level.

8. The computer-implemented method of claim 7, wherein:
reducing power usage further comprises determining non-essential services of the building to be turned off.

9. The computer-implemented method of claim 7, wherein:
reducing power usage further comprises reducing lighting to a minimum acceptable lighting level.

10. The computer-implemented method of claim 6, further comprising:
transmitting a proposal of reduced power usage.

11. A computer system for facilitating anonymous and automated communication comprising:
a processor;
a memory;
computer program instructions configured to cause the processor to perform the following method:
generating a profile for each user of a set of users of the building, using machine-learning techniques;
retrieving data regarding the building;
storing the profile and data in a knowledge base; and
calculating power requirements of the set of users based on the profile and data.

12. The computer-implemented method of claim 11, wherein:
the profile comprises a thermal profile of the user's thermal comfort level.

13. The computer-implemented method of claim 12, wherein:
the profile comprises building usage data regarding each user's use of other electric power of the building.

14. The computer-implemented method of claim 11, wherein:
calculating power requirements includes determining additional energy usage of the building not related to the set of users.

15. The computer-implemented method of claim 11, wherein:
the data regarding the building comprises data regarding building dimensions and orientation.

16. The computer-implemented method of claim 11, further comprising:
receiving a request for power usage information;
transmitting the power requirements;
receive request to reduce power usage;
using machine-learning techniques to reduce power usage using the profile.

17. The computer-implemented method of claim 16, wherein:
reducing power usage using the profile comprises changing a thermal comfort level of the building while maintaining a predicted percentage of dissatisfied below a predetermined level.

18. The computer-implemented method of claim 17, wherein:
reducing power usage further comprises determining non-essential services of the building to be turned off.

19. The computer-implemented method of claim 17, wherein:
reducing power usage further comprises determining non-essential services of the building to be turned off.

20. The computer-implemented method of claim 16, further comprising:
transmitting a proposal of reduced power usage.
